(19) United States
(12) Patent Application Publication
(10) Pub. No.: US 2005/0262291 A1
(43) Pub. Date: Nov. 24, 2005

(54) Method to write in a non-volatile memory and system to implement such method

(75) Inventors: Christoph Siegelin, Paris (FR); Laurent Csatillo, ST. Germain en Laye (FR)

Correspondence Address: PEHR JANSSON, ATTORNEY AT LAW, 7628 PARKVIEW CIRCLE, AUSTIN, TX, 78731, US

(73) Assignee: Axalto SA, Montrouge (FR)

(21) Appl. No.: 10/519,394

(22) PCT Filed: Jun. 27, 2003
(86) PCT No.: PCT/IB03/02509

§ 371 Date: Dec. 22, 2004

(30) Foreign Application Priority Data
Jun. 28, 2002 (EP) 02291626.6

(51) Int. Cl. G06F 12/00

(52) U.S. Cl. 711/103; 711/165

(57) ABSTRACT

This invention concerns a method to write in a Flash type memory of an electronic module. The method consists in: associating at least two physical areas of said memory, called mirror areas, with the same logical area and during a write in said logical area, in programming the content of said logical area in one of said blank mirror areas; erasing the content of all mirror area used in a single operation at a convenient time. This invention also concerns the smart card in which the method is implemented.

This invention concerns a method to write in a non volatile memory of an electronic assembly such as for example an onboard system. More precisely, the objective of this invention is to propose a method to optimise the time to write in this type of memory.

The invention also concerns an onboard system for the implementation of such a method.

The invention applies more especially to a smart card.

In the context of the invention, the term “onboard system” must be taken in its broadest sense. It concerns in particular all types of light terminals equipped with an electronic chip and more especially the smart cards as such. The electronic chip is itself equipped with information processing means (for example a microprocessor) and information storage means.

### TECHNICAL FIELD

Writing permanent data in a non volatile memory of an onboard system generally consists in a succession of erase/programming steps of said memory. Erasure consists in switching to “low” state (referred to later as ‘0’) all memory cells of a specific region (called “block” or “page”). Programming consists in switching to “high” state (written ‘1’) only part of said specific region. Writing consists in erasure of a region and programming suitable bits in said region.

On the present cards, the non volatile memory uses EEPROM technology. Write operations in EEPROM memory are very slow, about 4 ms. The erasure and programming times are similar, about half the write time i.e. approximately 2 ms. Consequently, the latencies induced by the writes in memory hide the true performance of the processor.

Currently, a new non volatile memory technology is emerging in smart cards: Flash technology. Flash technology differs from EEPROM technology especially as regards the significantly different characteristics of programming and erasure. In a Flash memory therefore, there is a large dissymmetry between the time required for programming, which is quite fast, and the time required to erase a previously programmed cell, identical to the time required for erasure in EEPROM memory. For example, the time required for programming may reach 10 μs (for a small amount of memory).

One objective of the invention is to optimise the write times in a non volatile memory of an electronic assembly equipped with Flash type memory.

Another objective of this invention is to propose a solution which could be implemented in an onboard system.

### SUMMARY OF THE INVENTION

This invention concerns a method to write in a Flash type memory of an electronic module characterised in that it consists in associating at least two physical areas of said memory, called mirror areas, with the same logical area and during a write in said logical area, in programming the content of said logical area in one of said blank mirror areas.

This invention also concerns the electronic module comprising information processing means, a FLASH type non volatile memory characterised in that it comprises a mirror memory formed from at least two physical areas and associated with the same logical area, each new programming operation in said logical area taking place in an area of the blank mirror memory as well as the card in which said module is integrated.

### BRIEF DESCRIPTION OF THE DRAWINGS

Other purposes, features and advantages of the invention will appear on reading the description which follows of the implementation of the method according to the invention and of a mode of realisation of an electronic system designed for this implementation, given as a non-limiting example, and referring to the attached drawings in which:

FIG. 1 is a schematic view of an example of realisation of an electronic module integrated in a portable object such as a smart card;

FIG. 2 is a schematic view of the steps of the method according to this invention;

FIG. 3 is a schematic view of a first mode of realisation of association between logical and physical areas in the method according to this invention;

FIG. 4 is a schematic view of a second mode of realisation of association between logical and physical areas in the method according to this invention;

FIGS. 5a to 5c are schematic views of the various types of write in the Flash type memory;

FIG. 6 is a schematic view of a first mode of realisation of erasure and regeneration of physical areas in the method according to this invention;

FIGS. 7a to 7c are schematic views of a second mode of realisation of erasure and regeneration of physical areas in the method according to this invention.

### WAY OF REALISING THE INVENTION

The method according to the invention aims to optimise the write time in a memory of an electronic assembly, and for example an onboard system such as a smart card, any portable object equipped with an electronic module. The electronic assembly includes at least a processor and a Flash type non volatile memory. In the following description, FLASH type memory means any non volatile memory displaying dissymmetry between the time required for programming and erasure.

Without this limiting its scope in any way whatsoever, the preferred application of the invention will be discussed below, i.e. applications based on integrated circuit cards.

Cards with integrated circuit also called smart cards are small plastic devices, which contain one or more embedded integrated circuits. A card with integrated circuit can be for example a memory card or a microprocessor card called also microprocessor chip card.

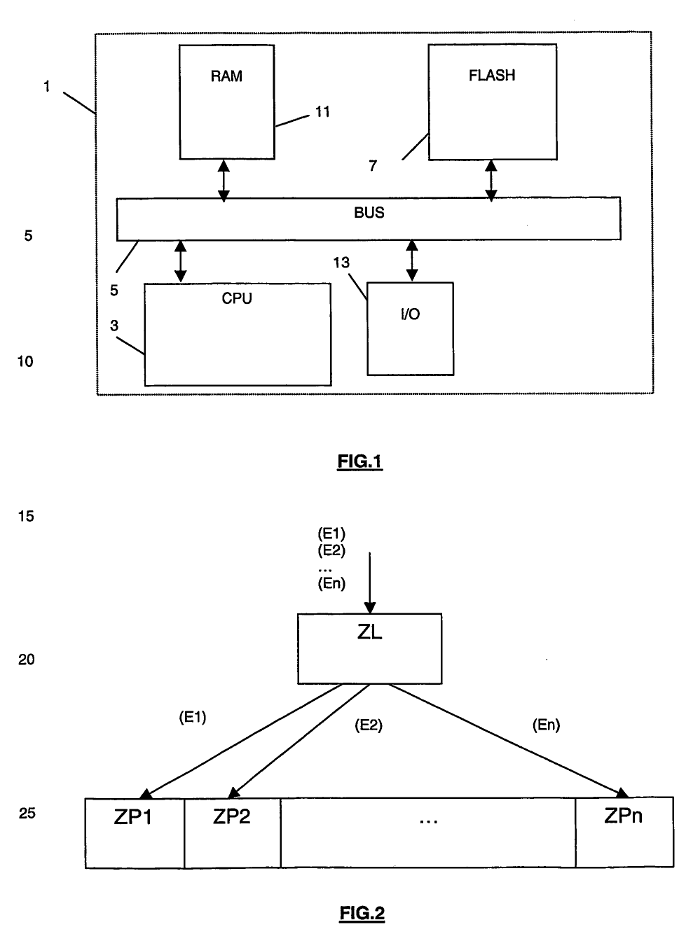

In a particular embodiment of the present invention shown in FIG. 1, the smart card 1 contains an integrated electronic unit 2: the electronic unit 2 comprises at least a microprocessor CPU 3 with two-way connection via an internal bus 5 to a non volatile memory 7 of type Flash storing at least a program to be executed, a volatile memory 11 of type RAM and input/output means 13 to communicate with the exterior. The unit 2 may comprise additional components not shown, connected to the internal bus. This type of unit is generally manufactured as a monolithic integrated electronic circuit, or chip, which once physically protected by any known means can be assembled on the integrated circuit card or similar for use in various fields, such as the bank and/or electronic payment cards, mobile radio telephony, pay television, health and transport.

This invention consists in a software method in order to benefit from the dissymmetry of the programming/erasure times of a non volatile memory, especially FLASH, to optimise the write times in non volatile memory of a smart card. A “mirror” memory is therefore defined and divided into n physical areas designed to contain the same logical area of the program.

FIG. 1 shows an example of mirror memory mechanism.

With the system in its initial state, all the mirror memory areas are blank, i.e. empty, ready to receive and store data. When the program wants to make a write E1 in the logical area ZL, it does so by programming (fast) the first physical area ZP1. ZP1 is the so-called active or current physical area in which the content of the logical area must be read. During the next write E2 on this logical area ZL, we avoid erasing (slow) the first physical area ZP1 by programming in the second physical area ZP2 (still blank). Area ZP2 becomes the active area. This method can be repeated until the mirror memory is saturated (or until the system finds a convenient time to erase the physical areas used, as will be seen below).

In order to re-use all physical areas, the mirror memory must be periodically erased. Erasure can be carried out at any time convenient for the system, and this erasure can benefit from the “block mode” of FLASH memories. The erasure of these physical areas is in fact optimised firstly by erasing all areas in a single operation and secondly by carrying out the erasure in a way that does not block the system.

A first method, known as “time multiplexing”, is a purely software realisation. Erasure is carried out by the card system when the system is waiting, especially for an external event such as a command from the terminal. A second method, known as “space multiplexing” requires a hardware support to execute concurrent tasks. The erasure task is in fact launched by the card system and executed in parallel with normal program execution. This second implementation will preferably be carried out either using a bi-port FLASH memory or using a bi-bank FLASH memory.

In short, separating the programming/erasure cycle described by the invention offers the advantage of fast programming in FLASH memory and optimises memory erasure operations. The invention therefore reaches a compromise between memory use and performance.

Several modes of realisation of the invention are described below, in three sections:
Section 1: Realisation of association between logical area/physical areas.
Section 2: Area write algorithm.
Section 3: Erasure and regeneration of physical areas.

Modes of realisation of the association between logical area/physical areas (Section 1) are described below. In order to make the association between logical area/physical areas, we need to know the active physical area (the current “mirror” area in which the content of the logical area must be read). It must be possible to quickly modify this data when changing physical area, to avoid penalising the programming operations. The data must therefore be stored in RAM or in a previously erased FLASH area.

A first realisation consists in a simple RAM counter, associated with the logical area, containing the number of the active area. The area is changed by incrementing the counter. When the card is initialised or in case of tearing, the physical areas are scanned to determine the number of areas “used” Zpu, i.e. the areas in which the content of the associated logical area at a given time has been programmed and not yet erased. The counter is initialised with this value.

FIG. 2 illustrates a write operation requiring a change of active physical area for this first realisation.

A second realisation consists in a bit field in FLASH, associated with the logical area. Each bit represents the use state of a physical area (‘1’→used; ‘0’→blank). The change of physical area is carried out by programming the bit corresponding to the newly active blank area. The complete bit field is erased when all physical areas are regenerated. For example, the active area may be determined as being the least significant area used in the bit field.

FIG. 3 illustrates a write operation requiring a change of active physical area for this second realisation.

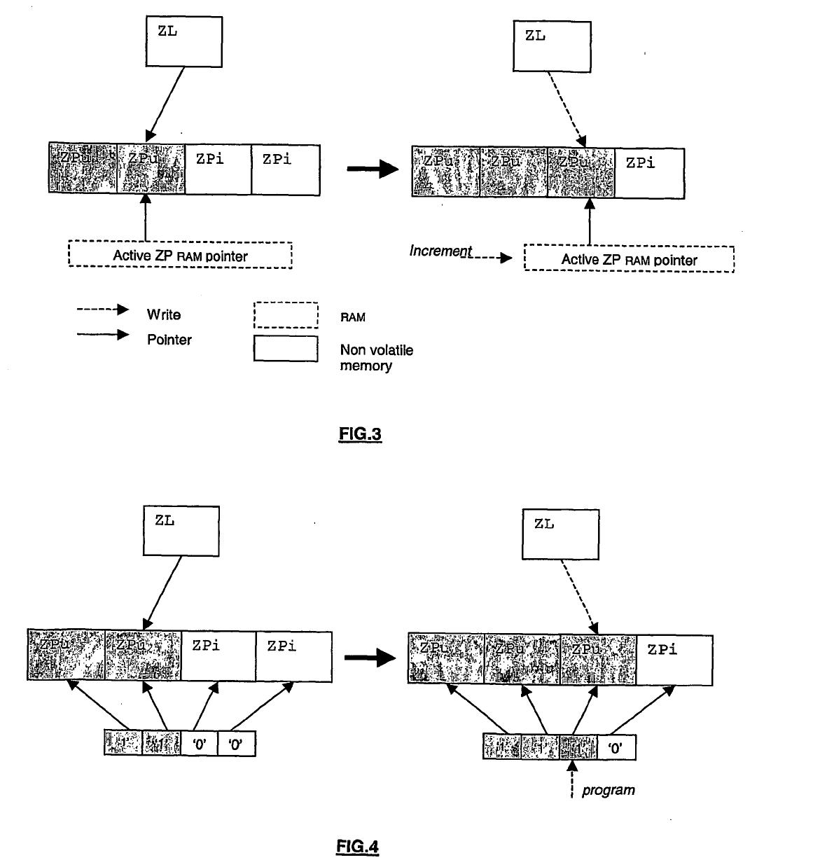

Modes of realisation of the write algorithm for an area (section 2) are described below, referring to FIGS. 4a to 4c which illustrate the various comparison operations. The active physical area on the left contains in bold the bits to be modified. The new active physical area (the same as the old area in FIG. 4a) and the bits actually programmed, in bold, are shown on the right.

In the simplest approach, writing the entire logical area involves using a new physical area, whereas a partial write of the logical area involves reading in the current physical area, replacing the appropriate portion then rewriting in a new physical area. This operation can be optimised by determining whether the current physical area can be re-used.

The method consists in first reading the current area and comparing it with the portion to be written.
If the two contents are identical, nothing is written and the active physical area remains the same (FIG. 4a).
If only bit programming operations are required (i.e. switch from ‘0’ to ‘1’), the active area is not changed and the corresponding bits are programmed in the current area (FIG. 4b).
Otherwise, the current area is read and masked by the portion to be written, then everything is programmed in a new active area (FIG. 4c).

Note that reading the current area beforehand does not have a significant impact on the performance of the method, since reads in non volatile memory are fast, just a few processor cycles. In addition, the content of the current area can be stored temporarily in RAM (which then acts as cache memory).

In a variant of the method (FIG. 4c) described above, the area is not entirely programmed, but just the portion which is actually different (greyed in the figure). Although this method involves more complex management, it may be better either because there is a significant gain when programming the non volatile memory or because the bit programming time is very high.

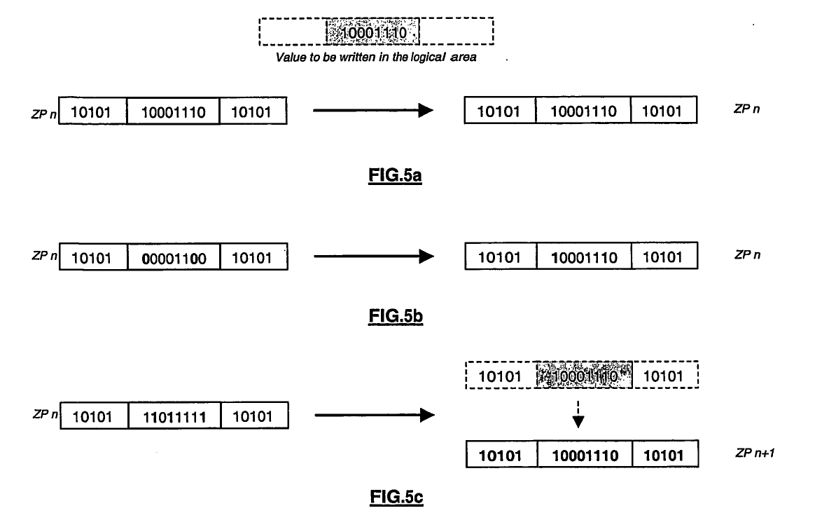

Modes of realisation of the regeneration of the physical areas (section 3) referring to FIG. 5 are described below.

“Time multiplexing” consists in separating the programming/erasure operations in time. In normal operation, the system only carries out programming. When it becomes inactive (or when all the areas are full), it erases them and is blocked during this period. For example, reception of a command on the I/O line of a smart card can be long (several hundred ms), the system takes advantage of this time to trigger an erase.

A purely software mechanism to erase the areas (FIG. 5) consists in copying the active physical area (the “mirror”) in a buffer area, then in erasing all mirror physical areas and lastly in copying the buffer into the first physical area available. This mechanism is illustrated in the following diagram.

“Space multiplexing” consists in carrying out in parallel the erase operation and the programming/read operations on the logical area. Bi-bank FLASH is used to carry out this multiplexing. The read/programming/erase operations are generally exclusive on a FLASH, in particular it is impossible to erase one memory area while programming or reading another. The bi-bank FLASH has two banks on which operations can be carried out in parallel (even though each bank has the same constraints as the traditional FLASH).

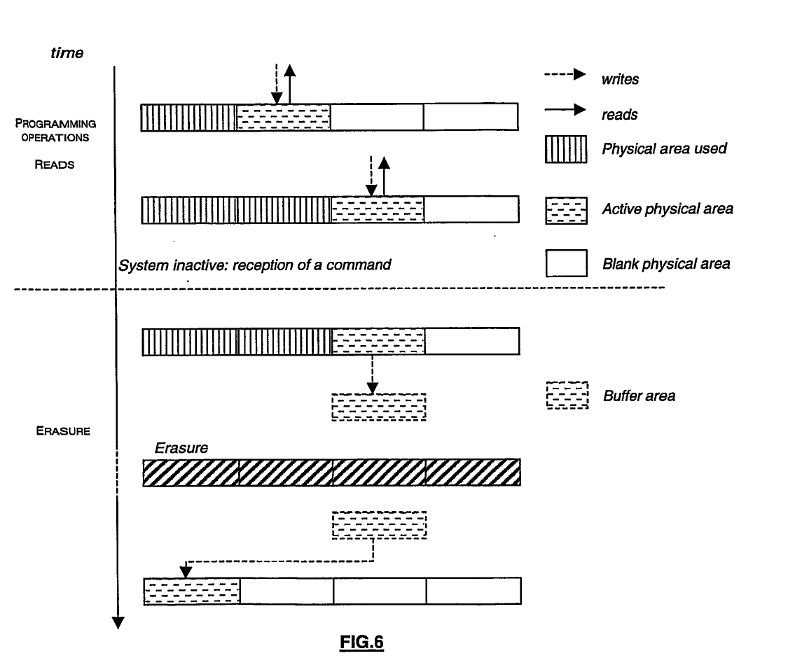

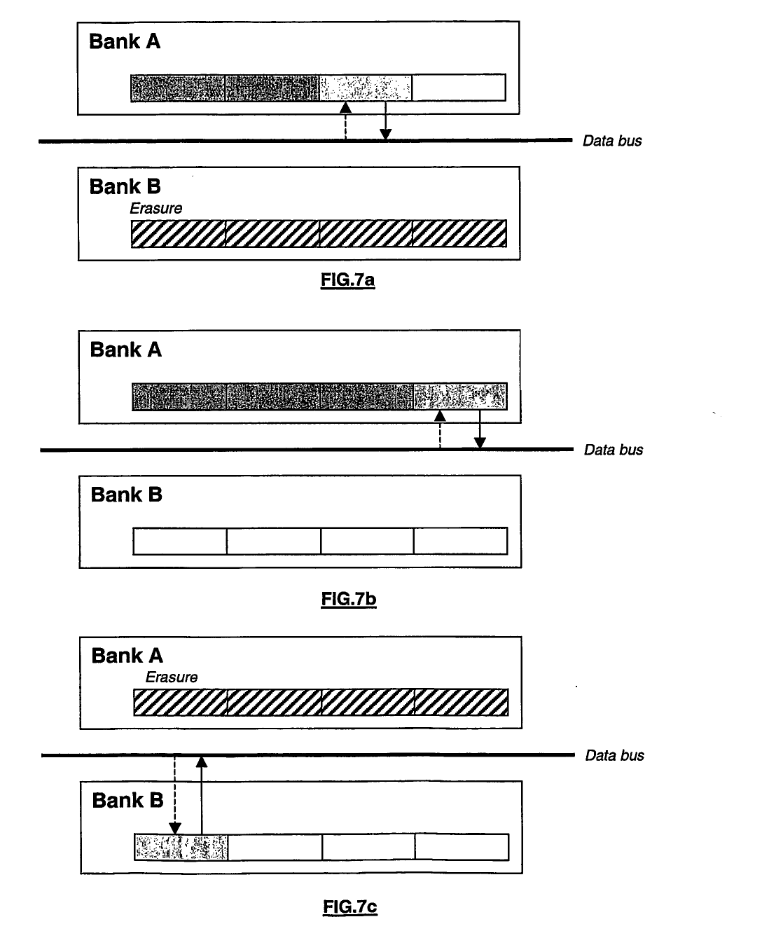

The realisation on this memory assumes that the logical area has at least one “mirror” area in each bank. The bank containing the active area is used for the programming and the read, whilst the mirror areas in the other bank are completely erased (if possible) at the same time. The system changes active bank when all the mirror areas of the bank have been used. FIGS. 6a to 6c illustrate this realisation.

On FIG. 6a, the programming/read operations are carried out on bank A whilst bank B is erased.

On FIG. 6b, B is erased, the system continues to work on A until the physical areas are saturated.

On FIG. 6c, when A reaches saturation, B becomes the active bank and the system erases A in parallel.

1. A method to write in flash type memory of an electronic module comprising associating at least two physical areas of said memory, called mirror areas, with the same logical area and during a write in said logical area, in programming the content of said logical area in one of said blank mirror areas, called the active area.

2. The method according to claim 1, comprising erasing the content of all mirror areas used in a single operation at a convenient time.

3. The method according to claim 2, comprising performing the erasure during a period of inactivity or when all the mirror physical areas are used.

4. The method according to one of claims 1 to 3, comprising copying the active physical area into a buffer area, erasing all mirror physical areas and copying the buffer into the first area available.

5. The method according to one of claims 1 to 3, comprising performing the erasure and programming/read operations in parallel without blocking the system.

6. The method according to claim 5, comprising performing the erasure and programming/read operations in parallel in a bi-bank memory, each bank having mirror area(s), one bank being used for programming/reading while the other bank is erased, the method changing active bank when all mirror areas of the bank used for programming/read have been used.

7. The method according to one of claims 1 to 6 claim 1, 2, or 3, comprising designating said active physical areas using a counter incremented on each change of active area.

8. The method according to one of claims 1 to 7 claim 1, 2 or 3, comprising associating at least one bit with a logical area representing the use state of at least one mirror physical area of said logical area.

9. The method according to one of claims 1 to 7 claim 1, 2, or 3, wherein the write is carried out in an active physical area if the content of the logical area is identical to the content of the active physical area or when said write involves no erasure, and in a blank physical area otherwise.

10. The method according to claim 9, characterized comprising programming only part of the logical area in the blank physical area.

11. An electronic module having information processing means and comprising a flash type non volatile memory having a mirror memory formed from at least two physical areas and associated with the same logical area, each new programming operation in said logical area taking place in an area of the blank mirror area.

12. A card characterized in that it includes comprising an electronic module having information processing means and comprising a flash type non volatile memory having a mirror memory formed from at least two physical areas and associated with the same logical area, each new programming operation in said logical area taking place in an area of the blank mirror area.

13. A computer program comprising program code instructions to cause a microprocessor to write in a flash type memory of an electronic module, wherein the computer program instructions comprise instruction for associating at least two physical areas of said memory, called mirror areas, with the same logical area and during a write in said logical area, in programming the content of said logical area in one of said blank mirror areas, called the active area.

14. The method according to claim 5, comprising designating said active physical areas using a counter incremented on each change of active area.

15. The method according to claim 6, comprising designating said active physical areas using a counter incremented on each change of active area.

16. The method according to claim 5, comprising associating at least one bit with a logical area representing the use state of at least one mirror physical area of said logical area.

17. The method according to claim 6, comprising associating at least one bit with a logical area representing the use state of at least one mirror physical area of said logical area.

18. The method according to claim 7, comprising associating at least one bit with a logical area representing the use state of at least one mirror physical area of said logical area.

19. The method according to claim 5, wherein the write is carried out in an active physical area if the content of the logical area is identical to the content of the active physical area or when said write involves no erasure, and in a blank physical area otherwise.

20. The method according to claim 6, wherein the write is carried out in an active physical area if the content of the logical area is identical to the content of the active physical area or when said write involves no erasure, and in a blank physical area otherwise.

21. The method according to claim 7, wherein the write is carried out in an active physical area if the content of the logical area is identical to the content of the active physical area or when said write involves no erasure, and in a blank physical area otherwise.

22. The method according to claim 19, comprising programming only part of the logical area in the blank physical area.

23. The computer program of claim 13, wherein the computer program instructions further comprise instructions to erase the content of all mirror areas used in a single operation at a convenient time.

24. The computer program of claim 23, wherein the computer program instructions further comprise instructions to, when erasing the content of all mirror areas used in a single operation at a convenient time, performing the erasure during a period of inactivity or when all the mirror physical areas are used.

25. The computer program of claim 13, 23, or 24 wherein the computer program instructions further comprise instructions to copy the active physical area into a buffer area, erasing all mirror physical areas, and copying the buffer into the first area available.

26. The computer program of claim 13, 23, or 24 wherein the computer program instructions further comprise instructions to perform the erasure and programming/read operations in parallel without blocking the system.

27. The computer program of claim 26, wherein the computer program instructions further comprise instructions to perform the erasure and programming/read operations in parallel in a bi-bank memory, each bank having mirror area(s), one bank being used for programming/reading while the other bank is erased, the method changing active bank when all mirror areas of the bank used for programming/read have been used.

28. The computer program of claim 13, 23, or 26 wherein the computer program instructions further comprise instructions to designate said active physical areas using a counter incremented on each change of active area.

29. The computer program of claim 13, 23, or 24 wherein the computer program instructions further comprise instructions to associate at least one bit with a logical area representing the use state of at least one mirror physical area of said logical area.

30. The computer program of claim 13, 23, or 24 wherein the computer program instructions further comprise instructions wherein the write is carried out in an active physical area if the content of the logical area is identical to the content of the active physical area or when said write involves no erasure, and in a blank physical area otherwise.

31. The computer program of claim 13, 23, or 24 wherein the computer program instructions further comprise instructions to program only part of the logical area in the blank physical area.
